(19) United States
(12) Patent Application Publication
(10) Pub. No.: US 2009/0182642 A1
(43) Pub. Date: Jul. 16, 2009

(54) METHODS AND SYSTEMS TO RECOMMEND AN ITEM

(76) Inventor: Neelakantan Sundaresan, Mountain View, CA (US)

Correspondence Address: SCHWEGMAN, LUNDBERG & WOESSNER/EBAY, P.O. BOX 2938, MINNEAPOLIS, MN, 55402, US

(21) Appl. No.: 12/169,553

(22) Filed: Jul. 8, 2008

Related U.S. Application Data
(60) Provisional application No. 61/020,869, filed on Jan. 14, 2008.

(51) Int. Cl. G06Q 30/00

(52) U.S. Cl. 705/26; 705/1

(57) ABSTRACT

Methods and Systems system for recommending an item. The system comprises at least one machine including a receiving module and a recommending module. The receiving module receives an event for an activity related to a first item. Next, the recommending module analyzes recommendation information to identify a first measure of association between the first item and a second item. The recommending module further analyzes recommendation information to identify a second measure of association between the second item and a third item. Finally, the recommendation module communicates a recommendation of the third item responsive to receipt of the event for the activity related to the first item.

### RELATED APPLICATIONS

This application claims the priority benefits of U.S. Provisional Application No. 61/020,869, filed Jan. 14, 2008 which is incorporated herein by reference.

### FIELD

The present application relates generally to the technical field of data processing.

### BACKGROUND

In a typical item-to-item recommender system, an item-to-item matrix is built where an intersection of a row and column may include a value that denotes how often the corresponding items were searched, bought, bid or purchased together. Item-pairs with a value that exceeds a threshold may be recommended together or individually used to trigger recommendation of the other item.

### BRIEF DESCRIPTION OF THE DRAWINGS

The present application is illustrated by way of example and not limitation in the figures of the accompanying drawings, in which like references indicate similar elements and in which:

FIG. 1 is a network diagram depicting a system, according to one example embodiment, having a client-server architecture;

FIG. 2 is a block diagram illustrating marketplace and payment applications, according to an embodiment;

FIG. 3 is a block diagram illustrating recommendation applications, according to an embodiment;

FIG. 4 is a block diagram illustrating tables, according to an embodiment, stored on a database;

FIG. 5 is a block diagram illustrating a user table, according to an embodiment;

FIG. 6 is a block diagram illustrating an recommendation table, according to an embodiment;

FIG. 7 is a block diagram illustrating recommendation information, according to an embodiment;

FIG. 8 is a flow chart illustrating a method, according to an embodiment, to update recommendation information;

FIG. 9 is a flow chart illustrating a method, according to an embodiment, to recommend an item;

FIG. 10 is a diagram illustrating an interface, according to an embodiment; and

FIG. 11 is a block diagram of a machine, according to an example embodiment, including instructions to perform any one or more of the methodologies described herein.

### DETAILED DESCRIPTION

Methods and system to recommend an item are described. In the following description, for purposes of explanation, numerous specific details are set forth in order to provide a thorough understanding of the present application. It will be evident, however, to one skilled in the art that the present application may be practiced without these specific details.

An example of the present disclosure includes a method and system to recommend an item. Specifically, an event may be received for an activity related to a first item. The activity may include a purchase of the first item, a bid for the first item or any other activity related to the first item. In response to receiving the event, the system may analyze recommendation information to identify a second item that is strongly associated to the first item. The recommendation information may have been previously collected as bid, purchase, search, browse, etc. events that are respectively related to the same items. The recommendation information may include multiple values that correspond to multiple item-pairs that respectively indicate a measure or strength of association between the items of the item-pair. For example, the recommendation information may include a value that exceeds a predetermined threshold to indicate a purchase of a digital camera item being strongly associated with a purchase of a digital camera accessory item. Continuing with the example, the system may continue by identifying a strong association between the second item and a third item of the same category or type as the first item. Finally, the system may respond to receipt of the event related to the first item by communicating a recommendation of the third item. If for example, the first item is a Panasonic digital camera that is identified to be strongly associated with a second item that is a battery charger, and the battery charger is identified to be strongly associated with a third item that is a Toshiba digital camera, then the digital cameras may be considered substitutable items and receipt of an event identifying one digital camera may be used to trigger a recommendation of the other.

### Platform Architecture

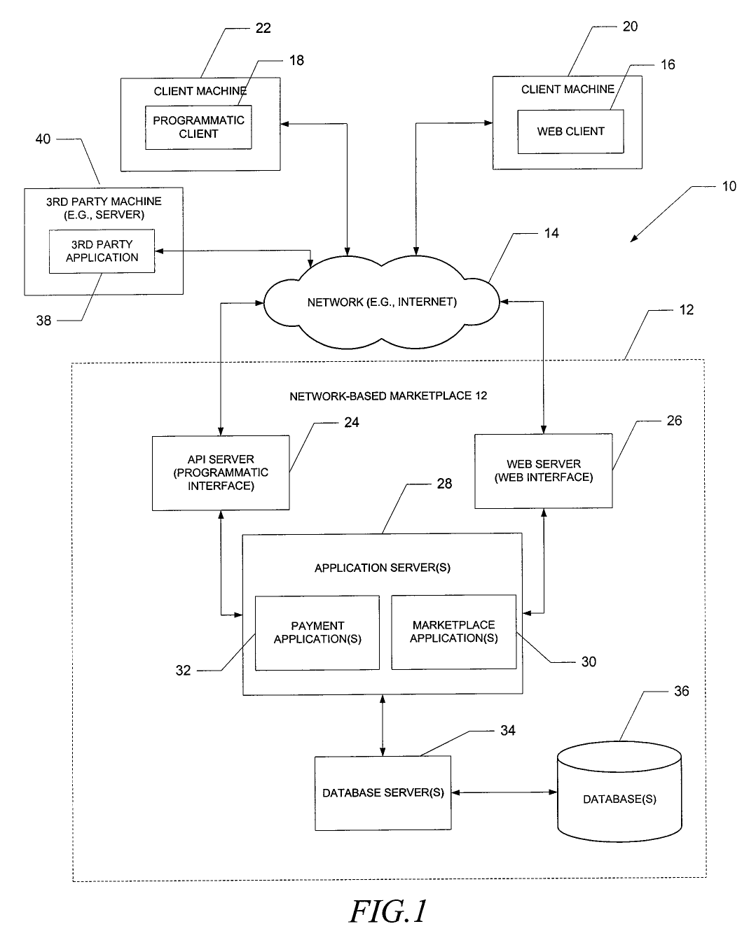

FIG. 1 is a network diagram depicting a system 10, according to one embodiment, having a client-server architecture. A commerce platform, in the form of a network-based marketplace 12, provides server-side functionality, via a network 14 (e.g., the Internet) to one or more clients. FIG. 1 illustrates, for example, a web client 16 (e.g., a browser, such as the Internet Explorer browser developed by Microsoft Corporation of Redmond, Wash. State), and a programmatic client 18 executing on respective client machines 20 and 22.

Turning specifically to the network-based marketplace 12, an Application Program Interface (API) server 24 and a web server 26 are coupled to, and provide programmatic and web interfaces respectively to, one or more application servers 28. The application servers 28 host one or more marketplace applications 30 and payment applications 32. The application servers 28 are, in turn, shown to be coupled to one or more databases servers 34 that facilitate access to one or more databases 36.

The marketplace applications 30 provide a number of marketplace functions and services to users that access the network-based marketplace 12. The marketplace applications 30 may, for example, be embodied as EBAY® services for processing exchange of goods and services, an online service offered by EBAY of San Jose, Calif. The payment applications 32 likewise provide a number of payment services and functions to users. The payment applications 32 may allow users to quantify for and accumulate value (e.g., in a commercial currency, such as the U.S. dollar, or a proprietary currency, such as “points”) in accounts, and then later to redeem the accumulated value for items (e.g., goods or services) that are made available via the marketplace applications 30. The payment applications 32 may, for example, be embodied as PAYPAL® services for processing electronic payment to and from others, an online service offered by EBAY of San Jose, Calif. While the marketplace and payment applications 32 and 32 are shown in FIG. 1 to both form part of the network-based marketplace 12, it will be appreciated that, in alternative embodiments, the payment applications 32 may form part of a payment service that is separate and distinct from the marketplace 12.

Further, while the system 10 shown in FIG. 1 employs a client-server architecture, the present disclosure is of course not limited to such an architecture, and could equally well find application in a distributed, or peer-to-peer, architecture system. The various marketplace applications 30 and payment applications 32 could also be implemented as standalone software programs, which do not necessarily have networking capabilities.

It should be appreciated that the web client 16 accesses the various marketplace applications 30 and payment applications 32 via the web interface supported by the web server 26. Similarly, the programmatic client 18 accesses the various services and functions provided by the marketplace applications 30 and payment applications 32 via the programmatic interface provided by the API server 24. The programmatic client 18 may, for example, be a seller application (e.g., the TURBOLISTER™ application developed by EBAY, INC., of San Jose, Calif.) to enable sellers to author and manage listings on the marketplace 12 in an off-line manner, and to perform batch-mode communications between the programmatic client 18 and the network-based marketplace 12.

FIG. 1 also illustrates a third party application 38, executing on a third party machine 40, as having programmatic access to the network-based marketplace 12 via the programmatic interface provided by the API server 24. For example, the third party application 38 may, utilizing information retrieved from the network-based marketplace 12, support one or more features or functions on a website hosted by the third party. The third party website may, for example, provide one or more promotional, marketplace or payment functions that are supported by the relevant applications of the network-based marketplace 12.

### Marketplace Applications

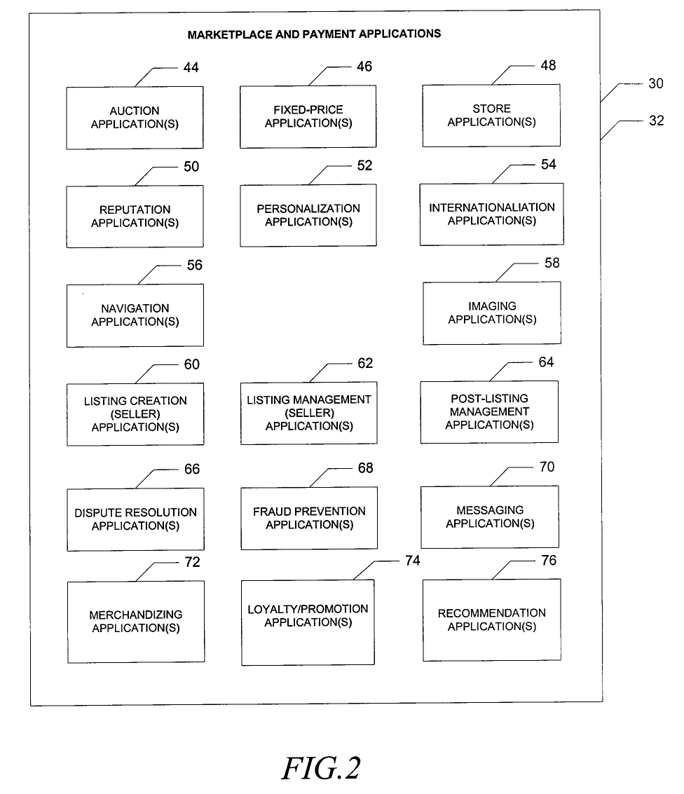

FIG. 2 is a block diagram illustrating multiple marketplace applications 30 and payment applications 32 that, in one embodiment, are provided as part of the network-based marketplace 12. The marketplace 12 may provide a number of listing and price-setting mechanisms whereby a seller may list goods or services (e.g., items) for sale, a buyer can express interest in or indicate a desire to purchase such goods or services, and a price can be set for a transaction pertaining to the goods or services. To this end, the marketplace applications 30 are shown to include one or more auction applications 44, which support auction-format listing and price setting mechanisms (e.g., English, Dutch, Vickrey, Chinese, Double, Reverse auctions etc.). The various auction applications 44 may also provide a number of features in support of such auction-format listings, such as a reserve price feature whereby a seller may specify a reserve price in connection with a listing and a proxy-bidding feature whereby a bidder may invoke automated proxy bidding.

A number of fixed-price applications 46 support fixed-price listing formats (e.g., the traditional classified advertisement-type listing or a catalogue listing) and buyout-type listings. Specifically, buyout-type listings may be offered in conjunction with an auction-format listing, and allow a buyer to purchase goods or services, which are also being offered for sale via an auction, for a fixed-price that is typically higher than the starting price of the auction. The fixed-price applications 46 may, for example, be embodied as BUY-IT-NOW (BIN)® services, an online service offered by EBAY, INC., of San Jose, Calif.

Store applications 48 allow sellers to group their listings within a “virtual” store, which may be branded and otherwise personalized by and for the sellers. Such a virtual store may also offer promotions, incentives and features that are specific and personalized to a relevant seller.

Reputation applications 50 allow parties that transact utilizing the network-based marketplace 12 to establish, build and maintain reputations, which may be made available and published to potential trading partners. Consider that where, for example, the network-based marketplace 12 supports person-to-person trading, users may have no history or other reference information whereby the trustworthiness and credibility of potential trading partners may be assessed. The reputation applications 50 allow a user, for example through feedback provided by other transaction partners, to establish a reputation within the network-based marketplace 12 over time. Other potential trading partners may then reference such a reputation for the purposes of assessing credibility and trustworthiness.

Personalization applications 52 allow users of the marketplace 12 to personalize various aspects of their interactions with the marketplace 12. For example a user may, utilizing an appropriate personalization application 52, create a personalized reference page at which information regarding transactions to which the user is (or has been) a party may be viewed. Further, a personalization application 52 may enable a user to personalize listings and other aspects of their interactions with the marketplace 12 and other parties.

In one embodiment, International Applications 54 may support a number of marketplaces that are customized, for example, for specific geographic regions. One version of the marketplace 12 may be customized for the United Kingdom, whereas another version of the marketplace 12 may be customized for the United States. Each of these versions may operate as an independent marketplace, or may be customized (or internationalized) presentations of a common underlying marketplace.

Navigation of the network-based marketplace 12 may be facilitated by one or more navigation applications 56. For example, a search application enables key word searches of listings published via the marketplace 12. A browse application allows users to browse various category, catalogue, or inventory data structures according to which listings may be classified within the marketplace 12. Various other navigation applications may be provided to supplement the search and browsing applications.

In order to make listings available via the network-based marketplace 12 as visually informing and attractive as possible, the marketplace applications 30 may include one or more imaging applications 58 specifying which users may upload images for inclusion within listings. An imaging application 58 also operates to incorporate images within viewed listings. The imaging applications 58 may also support one or more promotional features, such as image galleries that are presented to potential buyers. For example, sellers may pay an additional fee to have an image included within a gallery of images for promoted items.

Listing creation applications 60 allow sellers conveniently to author listings pertaining to goods or services that they wish to transact via the marketplace 12, and listing management applications 62 allow sellers to manage such listings. Specifically, where a particular seller has authored and/or published a large number of listings, the management of such listings may present a challenge. The listing management applications 62 provide a number of features (e.g., auto-relisting, inventory level monitors, etc.) to assist the seller in managing such listings. One or more post-listing management applications 64 also assist sellers with a number of activities that typically occur post-listing. For example, upon completion of an auction facilitated by one or more auction applications 44, a seller may wish to leave feedback regarding a particular buyer. To this end, a post-listing management application 64 may provide an interface to one or more of the reputation applications 50, so as to allow the seller to conveniently provide feedback regarding multiple buyers to the reputation applications 50.

Dispute resolution applications 66 provide mechanisms whereby disputes arising between transacting parties may be resolved. For example, the dispute resolution applications 66 may provide guided procedures whereby the parties are guided through a number of steps in an attempt to settle a dispute. In the event that the dispute cannot be settled via the guided procedures, the dispute may be escalated to a third party mediator or arbitrator.

A number of fraud prevention applications 68 implement various fraud detection and prevention mechanisms to reduce the occurrence of fraud within the marketplace 12.

Messaging applications 70 are responsible for the generation and delivery of messages to users of the network-based marketplace 12, such messages for example advising users regarding the status of listings at the marketplace 12 (e.g., providing “outbid” notices to bidders during an auction process or to provide promotional and merchandising information to users).

Merchandising applications 72 support various merchandising functions that are made available to sellers to enable sellers to increase sales via the marketplace 12. The merchandising applications 72 may also operate the various merchandising features that may be invoked by sellers, and may monitor and track the success of merchandising strategies employed by sellers.

The network-based marketplace 12 itself, or one or more parties that transact via the marketplace 12, may operate loyalty programs that are supported by one or more loyalty/promotions applications 74. For example, a buyer may earn loyalty or promotions points for each transaction established and/or concluded with a particular seller, and be offered a reward for which accumulated loyalty points can be redeemed.

The recommendation applications 76 may store and retrieve recommendation information that is used to recommend items to users. The recommendation applications 76 may work in conjunction with the merchandising applications 72 to provide the recommendations.

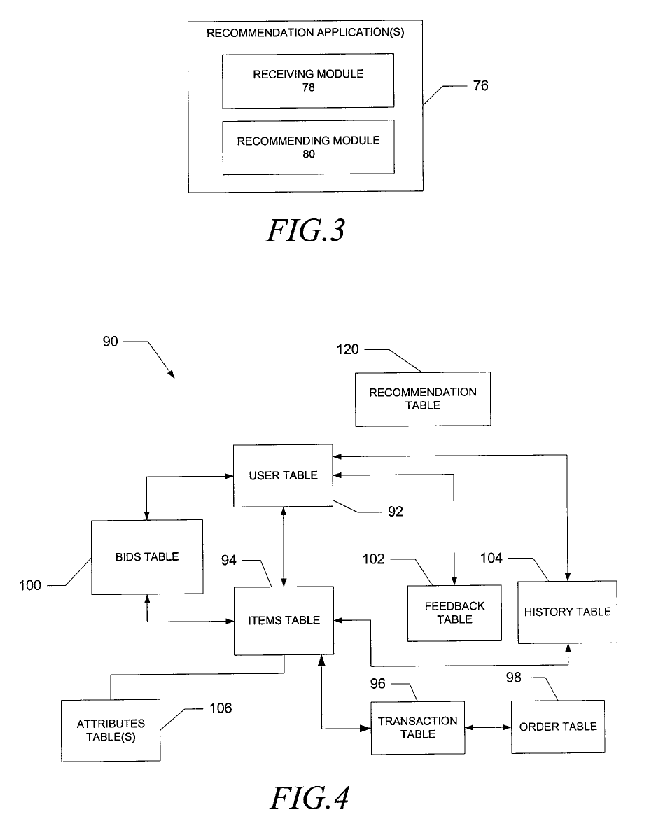

FIG. 3 is a block diagram illustrating recommendation applications 76, according to an embodiment. The recommendation applications 76 may include a receiving module 78 and a recommending module 80. The receiving module 78 may receive an event for an activity related to an item. For example, the activity may include a bid for the item, a search request that is used to generate search results including the item, a request to purchase the item, and a browse request that is used to generate search results including the item.

The recommending module 80 may process the event by generating or updating recommendation information. In addition, the recommending module 80 may process the event by analyzing the recommendation information related to the item and communicating a recommendation to purchase another item responsive to receiving the event.

### Data Structures

FIG. 4 is a high-level entity-relationship diagram, illustrating various tables 90 that may be maintained within the databases 36, and that are utilized by and support the marketplace applications 30 and payment applications 32. A user table 92 contains a record for each registered user of the network-based marketplace 12, and may include an identifier, address and financial instrument information pertaining to each such registered user. It should be appreciated that a user may operate as a seller, a buyer, or both the seller and buyer within the network-based marketplace 12. In one embodiment, a buyer may be a user that has accumulated value (e.g., commercial or proprietary currency), and is then able to exchange the accumulated value for items that are offered for sale by the network-based marketplace 12.

The tables 90 also include an items table 94 in which are maintained item records for goods and services that are available to be or have been transacted via the marketplace 12. Each item record within the items table 94 may furthermore be linked to one or more user records within the user table 92, so as to associate a seller and one or more actual or potential buyers with each item record.

A transaction table 96 contains a record for each transaction (e.g., a purchase transaction) pertaining to items for which records exist within the items table 94.

An order table 98 is populated with order records, each order record being associated with an order. Each order, in turn, may be with respect to one or more transactions for which records exist within the transactions table 96.

Bid records within a bids table 100 each relate to a bid received at the network-based marketplace 12 in connection with an auction-format listing supported by an auction application 44. A feedback table 102 is utilized by one or more reputation applications 50, in one embodiment, to construct and maintain reputation information concerning users. A history table 104 maintains a history of transactions to which a user has been a party. One or more attributes tables 106 record attribute information pertaining to items for which records exist within the items table 94. Considering only a single example of such an attribute, the attributes tables 106 may indicate a currency attribute associated with a particular item, the currency attribute identifying the currency of a price for the relevant item as specified in by a seller.

The recommendation table 120 stores recommendation information that is used by the recommendation applications 76 to recommend items.

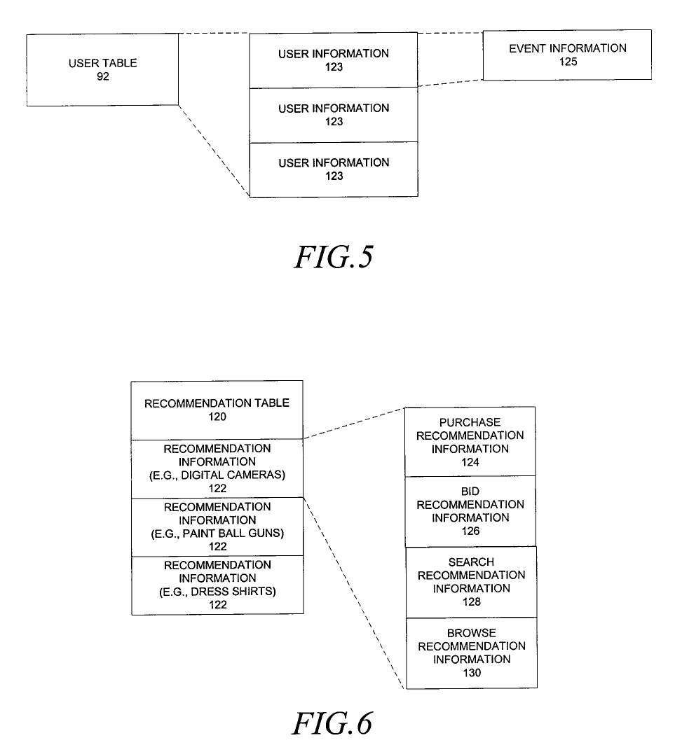

FIG. 5 is a block diagram illustrating a user table, according to an embodiment. The user table is shown to include user information 123 for each user on the system 10. The user information 123 includes event information 125. The event information 125 may be stored responsive to receiving events at the network-based marketplace 12 from a user that is identified. For example, the event information 125 may include a bid from a user, an item identifier that identifies an item for auction on the network-based marketplace 12, a user identifier that identifies the user making the request, and a time-stamp that identifies a time and date the event was received by the network-based marketplace 12.

FIG. 6 is a block diagram illustrating a recommendation table 120, according to an embodiment. The recommendation table 120 is used to store recommendation information 122. The recommendation information 122 may be stored according to categories. In one embodiment, the categories may be used to categorize an item on the network-based marketplace 12. For example, as illustrated, recommendation information 120 may be stored for digital cameras, paint ball guns, or dress shirts. In addition, within a category, the recommendation information 122 may be stored according to an activity related to an item. For example, an event to purchase a digital camera may be stored as purchase recommendation information 124 in recommendation information for digital cameras. Similarly, activities related to bidding, searching and browsing may be respectively stored as bid recommendation information 126, search recommendation information 128, and browse recommendation information 130 in the recommendation table 120.

The recommendation information 122 may be generated based on event information 125. Specifically, the recommendation information 122 may be stored responsive to receipt of an event associated with a particular user. For example, purchase recommendation information 124 may be stored based on receipt of a purchase event associated with a user, bid recommendation information 126 may be stored based on receipt of a bid event associated with a user, etc.

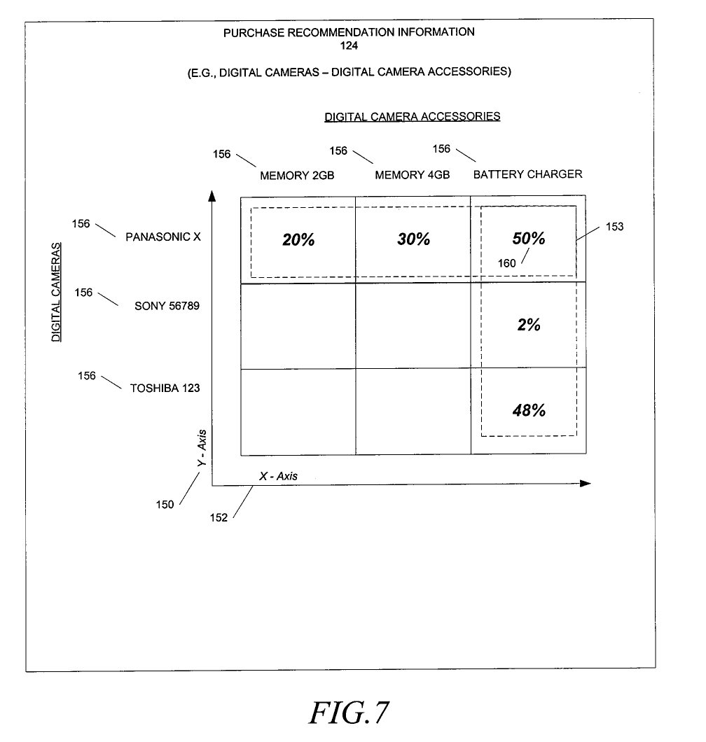

FIG. 7 is a block diagram illustrating purchase recommendation information 124, according to an embodiment. The purchase recommendation information 124 may be used by the network-based marketplace 12 to recommend an item. For example, the system 10 may receive an event from a user and analyze the recommendation information 122 to identify a recommendation for a digital camera that is communicated to the user.

The purchase recommendation information 124 is shown to be embodied as an item-to-item matrix including a Y axis 150 and an X axis 152. The Y axis 150 includes rows that respectively correspond to items 156 in the form of “Digital Cameras.” For example, the Y axis includes rows that correspond to the items 156 which may include “Sony 56789,” “Toshiba 123,” and “Panasonic X” digital cameras. The X axis 152 includes columns that respectively correspond to items 156 in the form of “Digital Camera Accessories.” For example, the X axis 152 includes columns that respectively correspond to “Memory 2 GB,” “Memory 4 GB,” and “Battery Charger” camera accessories.

An intersection 153 of a row and column may be used to store a recommendation value 160 for the identified item-pair. In one embodiment, the recommendation value 160 may be expressed as a measure or level of association between first and second items of the item-pair in the form of a percentage. For example, the item-to-item matrix may store a recommendation value 160 of 50% at the intersection of an item-pair including a “Panasonic X” digital camera and a “Battery Charger” digital camera accessory. Specifically, the recommendation value 160 may indicate a measure or strength of association between the two items (e.g., 50%). In one embodiment, a recommendation value of 50% may indicate that, on average, every second purchase of a “Panasonic X” digital cameras is associated with a purchase of a “Battery Charger” camera accessory.

In one embodiment, the recommendation values 160 may be generated or updated based on event information 125. For example, two purchase events (e.g., first event and second event) associated with a user may be identified to update an appropriate recommendation value 160 based on a predetermined criterion or criteria. Specifically, the predetermined criterion may be an elapsed time that is less than a predetermined amount or quantity of time (e.g., milliseconds, seconds, minutes, hours, days, etc.). The amount of elapsed time may by quantified by a receipt of the first event that is followed later by a receipt of a second event. In another embodiment, the amount of elapsed time may not be measured. Rather, the predetermined criterion may simply require that no intervening different event be received by the network-based marketplace 12 for the user. For example, receipt of a first purchase event from a user followed by receipt of second purchase event from the same user may trigger an update of the corresponding recommendation value 160 because no intervening different event was received (e.g., bid event, browse event, etc.). By way of contrast, receipt of a purchase event followed by receipt of a bid event may result in not updating the recommendation value 160 because receipt of the bid event may be deemed to be a receipt intervening different event. In yet another embodiment, criteria (e.g., multiple criterions) may be required to be satisfied before updating the recommendation value 160. For example, updating the recommendation value 160 may require satisfaction of a predetermined criterion in the form of an amount of time and satisfaction of a predetermined criterion in the form of no intervening different event, as described above.

The purchase recommendation information 124 may be used to make a recommendation as follows. In response to receiving an event (e.g., bid, browse, search, purchase, etc.) that includes an item identifier which corresponds to an item on the Y axis 150 of the purchase recommendation information 124, the network-based marketplace 12 may recommend one or more other items on the Y axis 150. For example, in response to receiving a bid for a “Panasonic X” digital camera 156, the network-based marketplace 12 may compare the recommendation values 160 along the X axis that are associated with the “Panasonic X” digital camera. Specifically, the network-based marketplace 12 may compare the recommendation values 160 for the item-pairs “Panasonic X—Memory 2 GB,” “Panasonic X—Memory 4 GB,” and the “Panasonic X—Battery Charger” with a predetermined criterion in the form of a predetermined threshold (e.g., 45%). In response to identifying a recommendation value 160 that is greater than the predetermined threshold (e.g., a strong association) the network-based marketplace 12 may commence comparing recommendation value(s) along the Y axis 150 in the corresponding column. For example, in response to identifying a strong association between the items in the item-pair “Panasonic X—Battery Charger,” the network-based marketplace 12 may begin comparing recommendation value(s) in the column headed by the “Battery Charger” to further identify additional item-pairs with strong association(s). For example, the system 10 may compare the recommendation values 160 for the item-pairs “Battery Charger—Sony 56789” and “Battery Charger—Toshiba 123” with a predetermined criterion in the form of a predetermined threshold (e.g., 45%). In response to identifying a recommendation value 160 that is greater than a predetermined threshold (e.g., a strong association) the network-based marketplace 12 may make a recommendation for the corresponding item 156 on the Y axis 150. For example, in response to identifying the recommendation values 160 for the item-pair “Battery Charger—Toshiba 123” being greater than the predetermined threshold (e.g., 45%), the network-based marketplace 12 may recommend the “Toshiba 123” digital camera.

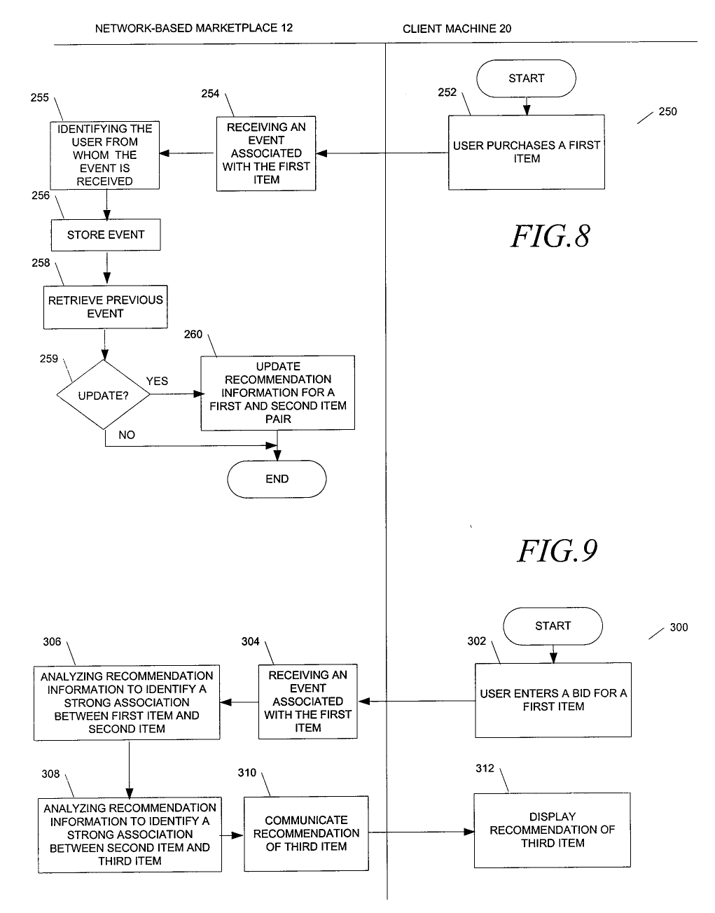

FIG. 8 is a flow chart illustrating a method 250, according to an embodiment, to update recommendation information 122. Illustrated on the right are operations performed on the client machine 20 and illustrated on the left are operations performed on the network-based marketplace 12. The method commences at operation 252, at the client machine 20, with a user selecting a user interface element to purchase a “Battery Charger” accessory.

At operation 254, at the network-based marketplace 12, the receiving module 78 receives an event that includes a request to purchase the “Battery Charger.” The event may further include an item identifier that identifies the “Battery Charger,” a user identifier that identifies the user that communicated the request and a time-stamp that identifies a time and date the event was received by the network-based marketplace 12.

At operation 255, the recommending module 80 may identify the event is received from the first user and, at operation 256, the recommending module 80 stores the event in the event information 125 for the first user.

At operation 258, the recommending module 80 may retrieve the event previous to the event from the event information 125 for the first user. In the present example, the previous event is for the purchase of a “Panasonic X” digital camera.

At decision operation 259, the recommending module 80 identifies whether purchase recommendation information 124 is to be updated by comparing the amount of time that has elapsed between the receipt of the event to request purchase of the “Panasonic X” digital camera and the receipt of the event to request purchase of the “Battery Charger” camera accessory. For example, the time-stamps on the respective events may be used to compute an elapsed time. If the amount of time is less than a predetermined threshold then a branch is made to operation 260. Otherwise the process ends. At operation 260, the recommending module 80 updates the appropriate recommendation value 160 for the item-pair “Battery Charger” accessory and “Panasonic X” digital camera in the purchase recommendation information 124 (e.g., intersection of “Battery Charger” and “Panasonic X”). For example, the recommending module 80 may be updated to a value of 50%.

In another embodiment the recommending module 80 may not update the recommendation value 160 responsive to the receipt of an event, but rather, update recommendation values 160 periodically (e.g., one time a day, one time a week, etc.) in the background. For example, in one embodiment, the operations 258, 259 and 260 may be performed asynchronously to operations 252, 254, 255 and 256.

FIG. 9 is a flow chart illustrating a method 300, according to an embodiment, to recommend an item. Illustrated on the right are operations performed on the client machine 20 and illustrated on the left are operations performed on the network-based marketplace 12. The method commences at operation 302, at the client machine 20, with a user selecting a user interface element to enter a bid for a first item in the form of a “Panasonic X” digital camera.

At operation 304, at the network-based marketplace 12, the receiving module 78 may receive an event that includes a request for entry of a bid for the “Panasonic X” digital camera. The event may include an item identifier that identifies “Panasonic X” digital camera, a user identifier that identifies the user making the request, and a time-stamp that identifies a time and date the event was received by the network-based marketplace 12.

At operation 306, the recommending module 80 may analyze bid recommendation 126 information to identify whether there exists a strong association between the “Panasonic X” digital camera and digital camera accessory items. For example, the recommending module 80 may identify a strong association by comparing the recommendation values 160 in the row associated with the “Panasonic X” digital camera to identify whether any of the recommendation values 160 in the row exceed a predetermined threshold. In the present example, the recommending module 80 may identify a strong association with a second item in the form of a “Battery Charger” because the corresponding recommendation value 160 exceeds a predetermined threshold.

At operation 308, the recommending module 80 may analyze the bid recommendation 126 information to identify a strong association between the second item and a third item. Specifically, the recommending module 80 may compare the recommendation values 160 in the column associated with the “Battery Charger” (e.g., column) to a predetermined threshold to identify whether any of the recommendation values 160 exceeds a predetermined threshold. In the present example, a single recommendation value 160 for the “Toshiba 123” digital camera exceeds the predetermined threshold. Accordingly, the “Toshiba 123” digital camera is the sole item that is identified to be strongly associated with the “Battery Charger.”

At operation 310, the recommending module 80, may communicate a user interface including a recommendation of the “Toshiba 123” digital camera to the client machine 20. In one embodiment, the user interface may further include user interface elements that enable purchase of the “Toshiba 123” digital camera. At operation 312, the client machine 20 may receive and display the user interface including the recommendation of the “Toshiba 23” digital camera.

In another embodiment, multiple recommendations may be communicated responsive to receiving an event. The multiple recommendations may be based on identifying multiple strong associations whether in a row or in a column of the recommendation information 122. Further, in another embodiment, different types of recommendation information 122 (e.g., purchase recommendation information 124 and bid recommendation information 126, etc.) may be used to identify levels or measures of association between items in an item-pair responsive to receipt of a single event. For example, purchase recommendation information 124 may be analyzed to identify a strong association between the first and the second item and bid recommendation information 126 may be analyzed to identify a strong association between the second and the third item. Further, in another embodiment, a first threshold may be utilized for row comparisons and a second threshold may be utilized for column comparisons.

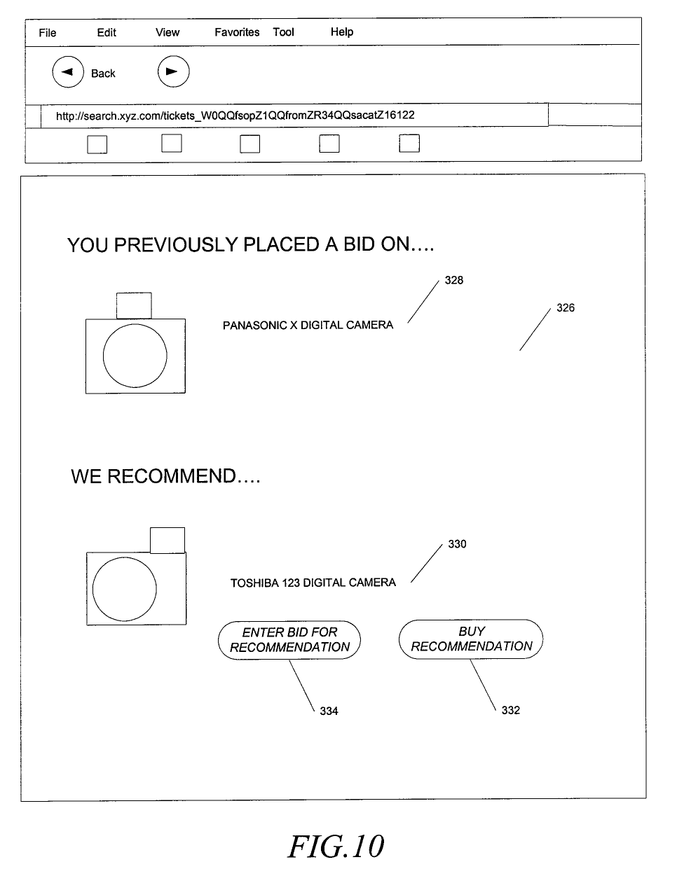

FIG. 10 is a diagram illustrating an interface 326, according to an embodiment. The interface 326 includes user interface elements 328 identifying a “Panasonic X” digital camera on which a bid was received and user interface elements 330 identifying a “Toshiba 123” digital camera that is recommended based on receipt of a bid for the Panasonic X digital camera. The interface 326 further includes a user interface element 332 that enables a purchase of the “Toshiba 123” digital camera for a fixed price and a user interface element 334 that enables an entry of a bid to purchase the “Toshiba 123” in an auction.

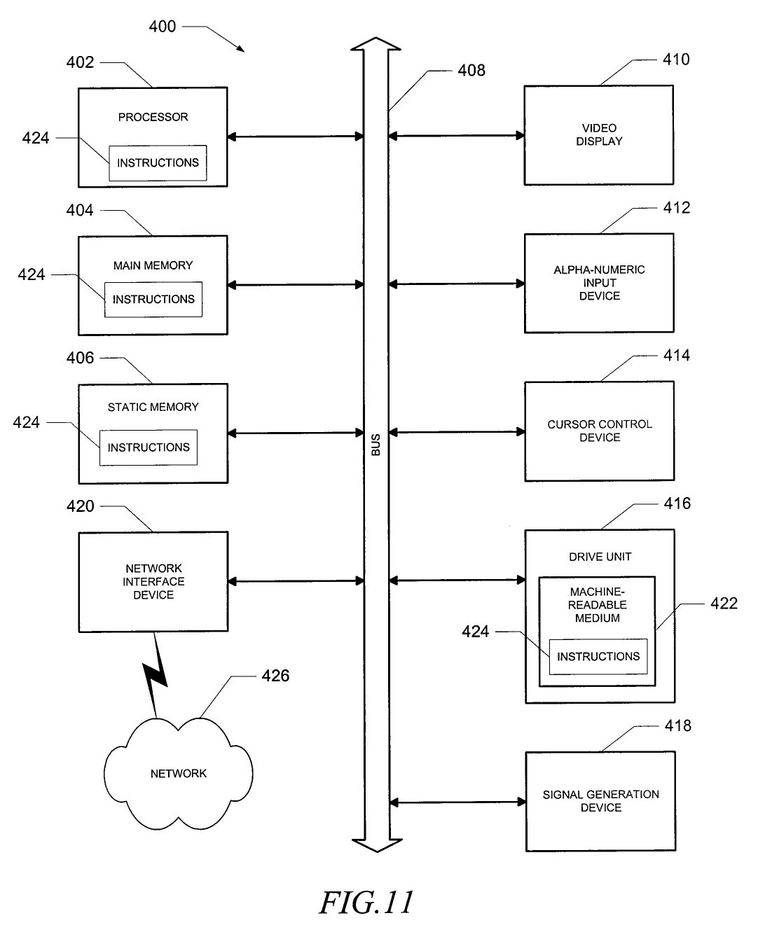

FIG. 11 shows a diagrammatic representation of machine in the form of a computer system 400 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The computer system 400 includes a processor 402 (e.g., a central processing unit (CPU) a graphics processing unit (GPU) or both), a main memory 404 and a static memory 406, which communicate with each other via a bus 408. The computer system 400 may further include a video display unit 410 (e.g., a liquid crystal display (LCD) or a cathode ray tube (CRT)). The computer system 400 also includes an alphanumeric input device 412 (e.g., a keyboard), a cursor control device 414 (e.g., a mouse), a disk drive unit 416, a signal generation device 418 (e.g., a speaker) and a network interface device 420.

The disk drive unit 416 includes a machine-readable medium 422 on which is stored one or more sets of instructions (e.g., software 424) embodying any one or more of the methodologies or functions described herein. The software 424 may also reside, completely or at least partially, within the main memory 404 and/or within the processor 402 during execution thereof by the computer system 400, the main memory 404 and the processor 402 also constituting machine-readable media.

The software 424 may further be transmitted or received over a network 426 via the network interface device 420.

While the machine-readable medium 422 is shown in an embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present application. The term “machine-readable medium” shall accordingly be taken to include, but not be limited to, solid-state memories, optical media and magnetic media.

### Technology

The methods and systems describe herein may be embodied in any one or more of the following technologies.

### JavaScript

JavaScript is a client-side object scripting language used by millions of Web pages and server applications. With syntax similar to Java and C++, JavaScript may behave as both a procedural and object oriented language. JavaScript is interpreted at run time on the client computer and provides various features to a programmer. Such features include dynamic object construction, function variables, dynamic script creation, and object introspection. JavaScript is commonly used to provide dynamic interactivity to Web-pages and interact with a page DOM hierarchy.

### JSON

JSON is an acronym for JavaScript Object Notation, and is a lightweight data exchange format. Commonly used in AJAX applications as an alternative to XML, JSON is human readable and easy to handle in client-side JavaScript. A single function call to evalo turns a JSON text string into a JavaScript object. Such objects may easily be used in JavaScript programming, and this ease of use is what makes JSON a good choice for AJAX implementations.

### AJAX

AJAX is an acronym for Asynchronous JavaScript and XML but has become synonymous for JavaScript applications that use the HTTP Request object. AJAX allows websites to asynchronously load data and inject it into the website without doing a full page reload. Additionally AJAX enables multiple asynchronous requests before receiving results. Overall the capability to retrieve data from the server without refreshing the browser page allows separation of data and format and enables greater creativity in designing interactive Web applications.

### HTML Push/Comet

Comet is similar to AJAX insomuch that it involves asynchronous communication between client and server. However, Comet applications take this model a step further because a client request is no longer required for a server response.

### Java NIO

Java NIO is an acronym for Java's New Input Output package, and is a new API that provides improved performance in such areas as buffer management, scalable network I/O, and file I/O. In particular, an NIO package may support non-blocking socket and file I/O. Non-blocking sockets remove the one socket per thread per client limitations of traditional web server implementations. This allows web servers using the NIO package to service multiple clients with a limited number of sockets and threads

### XSL

XSL is a transformation language that may be used to express XML in a different format. Similar to CSS, an XSL document describes how to format an XML hierarchy into HTML or other formats. Generally XSL is used to generate dynamic HTML pages from XML input.

### Other Technologies

An example embodiment may be implemented as a dynamic interface and use a set of tools consistent with this platform. In one embodiment, the server technology may include Tomcat and utilize custom java servlets which interface with a MYSQL database. In one embodiment, the communication protocol used for client-server communication may be XML. XML may be transformed on the client side by XSL documents. The interface itself may use AJAX to dynamically load content into the interface without refreshing.

### Modules, Components, and Logic

Certain embodiments are described herein as including logic or a number of modules, components or mechanisms. A module, logic, component or mechanism (herein after collectively referred to as a “module”) may be a tangible unit capable of performing certain operations and is configured or arranged in a certain manner. In example embodiments, one or more computer systems (e.g., a standalone, client or server computer system) or one or more components of a computer system (e.g., a processor or a group of processors) may be configured by software (e.g., an application or application portion) as a “module” that operates to perform certain operations as described herein.

In various embodiments, a “module” may be implemented mechanically or electronically. For example, a module may comprise dedicated circuitry or logic that is permanently configured (e.g., within a special-purpose processor) to perform certain operations. A module may also comprise programmable logic or circuitry (e.g., as encompassed within a general-purpose processor or other programmable processor) that is temporarily configured by software to perform certain operations. It will be appreciated that the decision to implement a module mechanically, in the dedicated and permanently configured circuitry, or in temporarily configured circuitry (e.g., configured by software) may be driven by cost and time considerations.

Accordingly, the term “module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which modules or components are temporarily configured (e.g., programmed), each of the modules or components need not be configured or instantiated at any one instance in time. For example, where the modules or components comprise a general-purpose processor configured using software, the general-purpose processor may be configured as respective different modules at different times. Software may accordingly configure the processor to constitute a particular module at one instance of time and to constitute a different module at a different instance of time.

Modules can provide information to, and receive information from, other modules. Accordingly, the described modules may be regarded as being communicatively coupled. Where multiple of such modules exist contemporaneously, communications may be achieved through signal transmission (e.g., over appropriate circuits and buses) that connect the modules. In embodiments in which multiple modules are configured or instantiated at different times, communications between such modules may be achieved, for example, through the storage and retrieval of information in memory structures to which the multiple modules have access. For example, a one module may perform an operation, and store the output of that operation in a memory device to which it is communicatively coupled. A further module may then, at a later time, access the memory device to retrieve and process the stored output. Modules may also initiate communications with input or output devices, and can operate on a resource (e.g., a collection of information).

Thus, methods and systems for recommending an item has been described. Although the present subject matter has been described with reference to specific exemplary embodiments, it will be evident that various modifications and changes may be made to these embodiments without departing from the broader spirit and scope of the subject matter. Accordingly, the specification and drawings are to be regarded in an illustrative rather than a restrictive sense.

1. A method for recommending an item, the method comprising:
receiving an event for an activity related to a first item;
analyzing recommendation information to identify a first measure of association between the first item and a second item;
analyzing recommendation information to identify a second measure of association between the second item and a third item; and
communicating a recommendation of the third item responsive to receiving the event for the activity related to the first item.

2. The method of claim 1, wherein the activity is selected from group of activities including a bid for the first item, a search request that is used to generate search results that includes the first item, a request to purchase the first item, and a browse request that is used to generate search results that includes the first item.

3. The method of claim 1, further including:
identifying the event is received from a first user;
storing the event in association with the first user;
retrieving a stored event previously received from the first user, the stored event associated with the second item;
identifying the event and the stored event are for updating recommendation information based on a predetermined criterion; and
updating the recommendation information for a first and second item-pair that includes the first item and the second item.

4. The method of claim 1, wherein the identifying the association between the first item and the second item includes identifying a level of association between the first item and the second item based on a first predetermined criterion.

5. The method of claim 1, further including:
analyzing recommendation information to identify a third measure of association between the second item and a fourth item
communicating a recommendation for the fourth item responsive to the receiving the event associated with the first item.

6. The method of claim 1, wherein the communicating the recommendation for the third item includes communicating a user interface element that enables purchase of the third item for a fixed price.

7. The method of claim 1, wherein the communicating the recommendation for the third item includes communicating a user interface element that enables entry of a bid to purchase the third item in an auction.

8. The method of claim 1, wherein the analyzing recommendation information to identify the first measure of association between the first item and the second item sale includes analyzing bid recommendation information to identify a level of association between the first item and the second item based on a predetermined criterion, wherein the predetermined criterion includes a percentage of bids that are received for the first item that are followed by receipt of a bid for the second item.

9. The method of claim 8, wherein the analyzing the recommendation information to identify the second measure of association between the second item and the third item includes analyzing purchase recommendation information to identify a level of association based on a predetermined criterion, wherein the predetermined criterion includes a percentage of requests that are received to purchase the first item that are followed by requests that are received to purchase the second item.

10. A system for recommending an item, the system comprising:
at least one machine including:
a receiving module to receive an event for an activity related to a first item; and
a recommending module to analyze recommendation information to identify a first measure of association between the first item and a second item, the recommending module to analyze recommendation information to identify a second measure of association between the second item and a third item and to communicate a recommendation of the third item responsive to receipt of the event for the activity related to the first item.

11. The system of claim 10, wherein the activity is selected from group of activities including a bid for the first item, a search request that is used to generate search results that includes the first item, a request to purchase the first item, and a browse request that is used to generate search results that includes the first item.

12. The system of claim 10, further wherein the recommendation module is to identify the event is received from a first user, store the event in association with the first user, retrieve a stored event previously received from the first user, the stored event associated with the second item, the recommendation module to identify the event and the stored event are for an update of recommendation information based on predetermined criteria, the recommendation module to update the recommendation information for a first and second item-pair that includes the first item and the second item.

13. The system of claim 10, wherein the recommendation module is to identify a level of association between the first item and the second item based on a first predetermined criterion.

14. The system of claim 10, wherein the recommendation module is to:
analyze recommendation information to identify a third measure of association between the second item and a fourth item; and
communicate a recommendation for the fourth item responsive to the receipt of the event associated with the first item.

15. The system of claim 10, wherein the recommendation module is to communicate a user interface element that enables a purchase of the third item for a fixed price.

16. The system of claim 10, wherein the recommendation module is to communicate a user interface element that enables an entry of a bid to purchase the third item in an auction.

17. The system of claim 10, wherein the recommendation module is to analyze bid recommendation information to identify a level of association between the first item and the second item based on a predetermined criterion, wherein the predetermined criterion includes a percentage of bids that are received for the first item that are followed by receipt of a bid for the second item.

18. The system of claim 17, the recommendation module is to analyze purchase recommendation information to identify a level of association based on a predetermined criterion, wherein the predetermined criterion between the second item and the third item includes a percentage of requests that are received to purchase the first item that are followed by requests that are received to purchase the second item.

19. A system for recommending an item, the system comprising:
at least one machine including:
a first means for receiving an event for an activity related to a first item; and
a recommending module for analyzing recommendation information to identify a first measure of association between the first item and a second item, the recommending module for analyzing recommendation information to identify a second measure of association between the second item and a third item and for communicating a recommendation of the third item responsive to receipt of the event for the activity related to the first item.

20. A machine-readable medium for storing instructions that, when executed by a machine, cause the machine to:
receive an event for an activity related to a first item;
analyze recommendation information to identify a first measure of association between the first item and a second item;
analyze recommendation information to identify a second measure of association between the second item and a third item; and
communicate a recommendation of the third item responsive to receiving the event for the activity related to the first item.
